(19) United States
(12) Patent Application Publication
(10) Pub. No.: US 2004/0025387 A1
(43) Pub. Date: Feb. 12, 2004

(54) Method of advertising on golf balls

(76) Inventor: Mark Richardson, Mississauga (CA)

Correspondence Address: Elias C. Borges, Suite 406, 1 Eva Road, Toronto, ON, M9C 4Z5, CA

(21) Appl. No.: 10/634,690

(22) Filed: Aug. 5, 2003

Related U.S. Application Data
(60) Provisional application No. 60/402,307, filed on Aug. 5, 2002.

(51) Int. Cl. G09F 3/00

(52) U.S. Cl. 40/327

(57) ABSTRACT

An improved method of advertising a companies trademarks using golf balls is disclosed. The method of the present invention includes the steps of acquiring a quantity of golf balls from a golf ball supplier, marking the golf balls at a central location with trademarks belonging to the companies and then distributing the marked golf balls to a plurality of different driving ranges. The driving ranges each have a plurality of tee areas from which golf balls are played by the members of the target audience and a field adjacent to said tees into which the played golf balls land. Each driving range distributes quantities of marked golf balls to the members and allows the members to play the marked golf balls at the tees. After the balls are played, they are collected from the fields and then redistributed to the members of the target audience to be played again at the tees. After the balls have each been worn out, the balls are removed from the driving range.

### CROSS REFERENCE TO RELATED APPLICATION

This application claims priority from provisional application serial No. 60/402,307 which was filed on Aug. 5, 2002, the entirety of which is hereby incorporated by reference.

### FIELD OF THE INVENTION

The invention relates generally to methods of advertising and promoting company names and/or trademarks.

### BACKGROUND OF THE INVENTION

It is a well known method of promoting a company's products and/or services by distributing promotional products bearing the company name and/or trademark to potential customers. Various promotional products have traditionally been distributed, including pens, coffee mugs, ball caps, letter openers, calendars, mouse pads and the like. Due to the popularity of the game of golf, golf balls have often been used as a promotional product in this way. Often, large companies will apply their trademarks to a plurality of golf balls and then distribute the golf balls to various customers, employees or other members of the public. Many decision makers, both in the public and private sectors including accountants, lawyers, doctors, corporate executives and other professionals are either golf enthusiasts or occasional golf players. Therefore, golfers, as a group, are often a desirable target audience for a number of corporate advertisers.

While distributing golf balls to potential customers or sales leads may be perceived as somewhat of an effective way to promote a company's products or services, the costs of this promotional technique relative to market penetration and exposure can be quite prohibitive. In other words, exposure to the target market in all likelihood, will be limited and short lived. 5 Firstly, the cost of quality golf balls can be prohibitively expensive. Also, the costs associated with imprinting a company name and/or trademark on a plurality of golf balls can, in many cases, be relatively high. Finally, the cost of distributing these golf balls to the target market may also be very high relative to the limited exposure and longevity. As a result, there are many companies that, for one or more of these reasons, would not choose the use of golf balls as an advertising medium. Therefore, a cost effective method relative to market exposure and longevity in promoting the products and/or services of a company using golf balls would find quick acceptance in the marketplace.

### SUMMARY OF THE INVENTION

The present invention overcomes the drawbacks of the prior art by providing a method of simultaneous promoting a number of different companies to members of a target audience who play golf which results in the members being repeatedly exposed to the same advertisement. The method of the present invention includes the steps of acquiring a quantity of golf balls from a golf ball supplier, marking the golf balls at a central location with trademarks belonging to the companies and then distributing the marked golf balls to a plurality of different driving ranges. The driving ranges each have a plurality of tee areas from which golf balls are played by the members of the target audience and a field adjacent to said tees into which the played golf balls land. Each driving range distributes quantities of marked golf balls to the members and allows the members to play the marked golf balls at the tees. After the balls are played, they are collected from the fields and then redistributed to the members of the target audience to be played again at the tees. After the balls have each been played a number of times, the balls are removed from the driving range.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a schematic view of the method of the present invention.

FIG. 2. is a schematic representation of a golf facility as used in the present invention.

In the drawings like characters of reference indicate corresponding parts in the different figures.

### DETAILED DESCRIPTION OF THE INVENTION

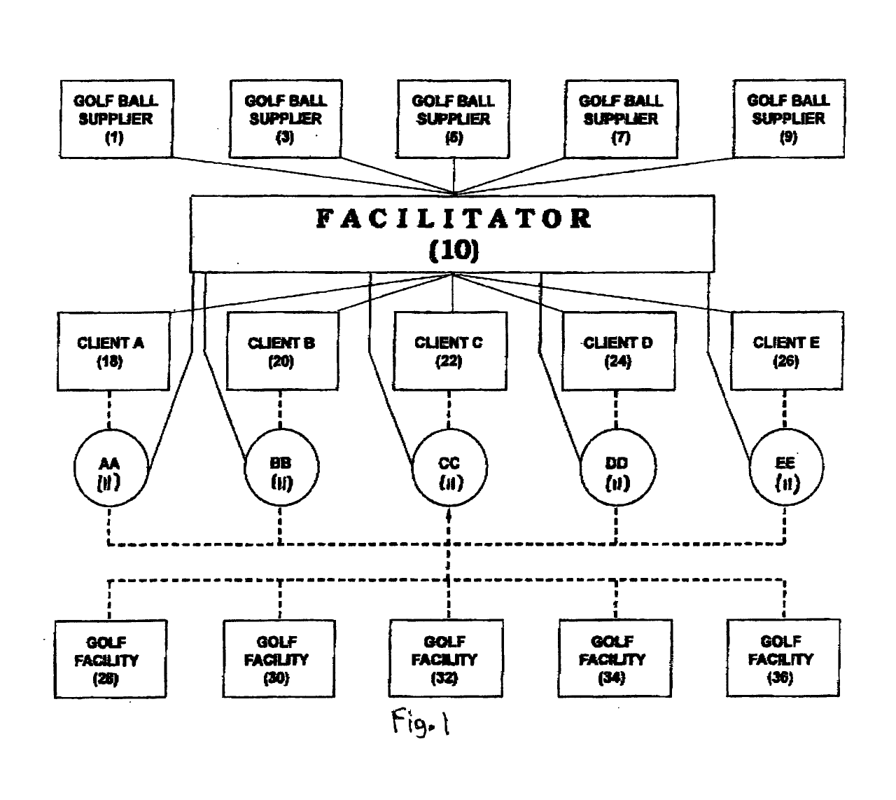

The method of the present invention is shown schematically in FIG. 1. Facilitator 10 has access to a large number of golf balls which it obtains from one or more golf ball suppliers represented by item numbers 1, 3, 5, 7 and 9. Facilitator 10 executes advertising contracts with clients A, B, C, D and E represented by item numbers 18, 20, 22, 24 and 26. As part of the contractual relationship between the facilitator 10 and clients A, B, C, D and E, the facilitator agrees to imprint a graphical representation of the client's trademarks such as the client's corporate name and/or logo on the golf balls 11. Hence the facilitator 10 produces a contractually determined number of golf balls bearing the trademark image AA which is the trademark of client 18. Likewise, facilitator 10 imprints a trademark image representing the corporate name and/or trademark logo of client 20 on a contractually determined number of golf balls represented by BB. Likewise, facilitator 10 imprints the corporate name and/or logo of client 22 on a contractually determined number of golf balls represented by CC. Likewise, facilitator 10 imprints the corporate name and/or trademark logo of client 24 on a contractually determined number of golf balls represented by DD. Likewise, facilitator 10 imprints the corporate name and/or trademark logo of client 26 on a contractually determined number of golf balls represented by EE. Facilitator 10 maintains a central location where the golf balls are to be marked and stored for shipment. The central location may have printing equipment suitable for marking the trademark images onto the golf balls. Suitable golf ball printing equipment is readily available. The central location may actually be owned by facilitator 10, or the facilitator may simple contract out the marking of the golf balls to a printer who maintains a printing facility. Alternatively, the golf balls may be marked by the golf ball supplier on instructions from the facilitator.

Facilitator 10 has executed golf ball supply contracts with golf facilities 28, 30, 32, 34 and 36. Pursuant to the terms of these golf ball supply contracts, facilitator 10 provides each of the golf facilities with a plurality of practice range golf balls at a reduced price or in some cases the facilitator 10 may supply golf balls at no cost to the golf facility or in certain other cases may even offer a revenue sharing program to the golf facility based on the advertising revenue generated through contracts with it's clients. Hence, the facilitator supplies it's golf facility network with golf balls AA, BB, CC, DD and EE. The golf balls are distributed throughout this network randomly or in some cases based on demographic research in order to maximize client exposure. The distribution is based on agreements between the facilitator 10 and it's clients 18, 20, 22, 24 and 26 as well as between it's golf facility network 28, 30, 32, 34 and 36. Therefore, a particular golf facility may have one or more client corporate names and/or trademarks represented on a plurality of practice range golf balls.

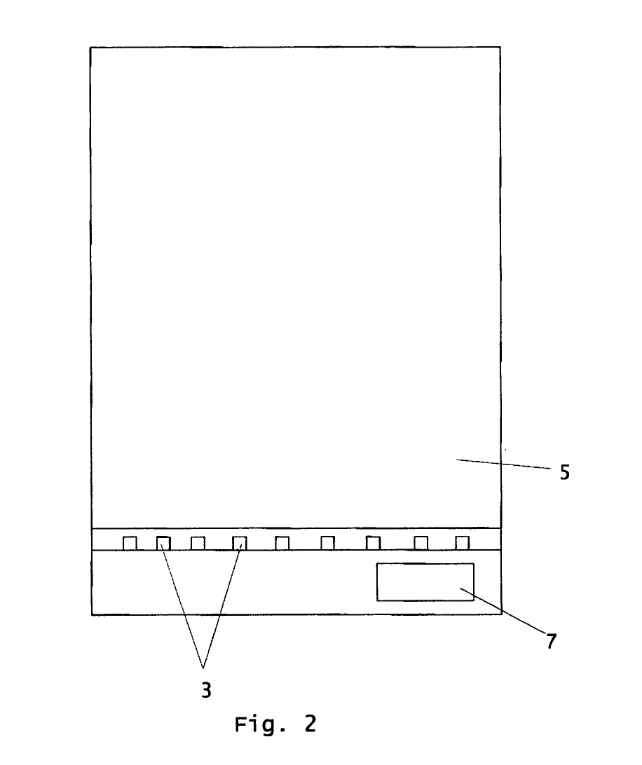

As best seen in FIG. 2, golf facilities 28, 30, 32, 34 and 36 are comprised of driving ranges including putting and chipping areas as part of the golf facility and may be public, semiprivate or private. Each driving ranges consisting of a plurality of tee areas 3 and a field 5 adjacent the tees. People practising at the driving range will drive their balls from the tee areas and into the field. Each golf facility will also have an operator 7 who controls the distribution of the golf balls to players who wish to practice at the driving range. The operator will generally consist of people staffed by the owner(s) of the golf facility. Pursuant to the agreement between the facilitator 10 and the golf facilities 28, 30, 32, 34 and 36, each of the golf facilities would use only those balls provided by the facilitator 10. Notwithstanding, there may be instances where facilitator 10 supplied golf balls, particularly in the initial set-up stage would be mixed with existing golf facility range ball inventories. As a result, individuals using the various golf facilities will eventually be using only those golf balls provided by the facilitator 10 bearing the corporate name and/or trademark of clients 18, 20, 22, 24 and 26. In the present example, an individual using a golf facility practice area 28, 30, 32, 34 and 36 would obtain a bucket of practice balls many or all bearing a client 18, 20, 22, 24 and 26 corporate name and/or trademark AA, BB, CC, DD and EE. The individual then plays the bucket of balls as he would any other bucket of balls. The individual drives the balls into the field, where the balls land. Eventually, the operator collects the played balls which have landed on the field. These collected balls are then made available to other individuals who desire to practice at the driving range. The cycle of playing and retrieving the balls continues until the balls have become worn, at which point they are removed from the facility and replaced with fresh balls. The worn out golf balls may be returned to the central facility maintained by the facilitator to be replaced by fresh golf balls, or the worn out golf balls may simply be disposed of.

In order to make the system more appealing to the individual golfer, facilitator 10 will mark a small percentage of the balls with a special marking and distributed these specially marked balls to the golf facilities. The golf facilities will then distribute the specially marked balls to the members playing at the facility. Preferably, the specially marked balls are distributed along with the other marked golf balls, such that not every bucket of balls will contain a specially marked ball. The specially marked balls may be redeemed by the member/player finding the ball for prizes. The prizes may be redeemable by the player at either the golf facility, the facilitator or the specially marked ball may be redeemable at the company whose trademark image was applied to the ball. The prize could include a free bucket of balls to be played at the facility, or some other golf related product, or some product or service which is not golf related. This will motivate the individual to look at each and every ball and take notice of the imprinted corporate name and/or trademarks.

Golf facilities 28, 30, 32, 34 and 36 will generally be geographically disbursed. The facilitator 10 can take advantage of this geographic diversity by contracting with different clients. For example if golf facility 28 is positioned near client 18 facilitator 10 may convince client 18 to advertise the client's corporate name and/or trademark on golf balls distributed to golf facility 28. Since individuals using golf facility 28 would be exposed to client 18's trademark while using the golf facilities, and since client 18 is geographically located near golf facility 28, the advertising impact on the individual would be relatively high.

In other cases, a client may wish to advertise and promote their corporate name and/or trademark over a broader geographical area. In this example client 20 may wish to promote it's corporate name and/or trademark among golf enthusiasts in a number of different golf facilities. Facilitator 10 would then distribute golf balls BB bearing client 20's corporate name and/or trademark to golf facilities 28, 30, 32, 34 and 36. Since these balls BB are distributed to a number of golf facilities within the network, a broader group of golf enthusiasts will be exposed to client 20's corporate name and/or trademark.

Golf facilities 28, 30, 32, 34 and 36 would continue to use the golf balls supplied by the facilitator 10 until such time as the balls are worn out or lost. The attrition factor on the golf balls and the recycling and/or the topping up golf ball inventories within the network of golf facilities is managed under the terms and conditions of the individual contracts between the facilitator 10 and it's advertising clients 1 8, 20, 22, 24 and 26 as well as it's individual contracts with golf facilities 28, 30, 32, 34 and 36.

In exchange for imprinting a client's corporate name and or trademark onto the golf balls AA, BB, CC, DD and EE and distributing these balls within the facilitator's golf facility network, the facilitator 10 will charge the client a fee as agreed to under the terms and conditions of an agreement between the client and the facilitator. The fee charged will vary depending on the number of balls introduced into the network and any other obligations the facilitator 10 has to the client pursuant to the agreement.

The present method has several advantages over the prior art. Firstly, the facilitator 10 may utilize any number of golf ball suppliers in purchasing a large volume of imprinted golf balls which may be at a much reduced price. Furthermore, since the facilitator 10 has contracts with a number of different clients, the costs associated in purchasing and imprinting the golf balls may, in part, be passed to the client advertiser. Finally, since the facilitator 10 has contractual relationships with many different golf facilities, the facilitator 10 can take advantage of economies of scale in delivering these golf balls to the various golf facilities. The net result being, the facilitator 10 is able to provide clients 18, 20, 22, 24 and 26 with a cost effective means of presenting the golf balls bearing their corporate name and/or trademark to a large number of golf enthusiasts playing at a variety of golf facilities.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A method of promoting a number of different companies to members of a target audience comprising the following steps:
a) acquiring a quantity of golf balls from a golf ball supplier,
b) marking said golf balls at a central location with trademark images belonging to the companies;
c) distributing said marked golf balls from the central location to a plurality of different driving ranges, the driving ranges each having a plurality of tee areas from which golf balls are played by the members of the target audience and a field adjacent to said tees into which the played golf balls land,
d) distributing quantities of marked golf balls at the driving ranges to the members and allowing said members to play the marked golf balls at the tees,
e) collecting the marked golf balls from the fields after the balls have been played and then redistributing said played balls to the members of the target audience to be played again at the tees,
f) repeating step e) a number of times, and
g) removing the golf balls from the driving range after the golf balls have been played said number of times.

2. The method of claim 1 wherein each golf ball is marked with the trademark images of only one company.

3. The method of claim 2 wherein each driving range receives a variety of differently marked golf balls and wherein the operator of the driving range provides at least some of the members with a variety of differently marked golf balls.

4. The method of claim 2 wherein at least some of the driving ranges receive only identically marked golf balls from the central location.

5. The method of claim 1 wherein the golf balls are played until they become worn before being removed from the driving range.

6. The method of claim 1 wherein each member of the target audience playing at the driving range receives a plurality of marked golf balls each time the member plays.

7. The method of claim 1 wherein the driving ranges are selected to lie within a preselected geographic area, the preselected geographic area corresponding to the geographic areas the companies wish to promote their trademarks.

8. The method of claim 3 wherein the played golf balls are removed from the driving ranges after a time period, the time period selected to remove the balls before the balls become worn out.

9. A method of advertising a company to members of a target audience comprising the following steps:
a) receiving an order from a company to promote a trademark image belonging to the company to the members of the target audience,
b) acquiring a quantity of golf balls from a golf ball supplier,
c) marking said golf balls with the trademark image;
d) distributing the marked golf balls to a plurality of driving ranges to be played by the members of the target audience,
e) removing the marked golf balls from the driving range after the golf balls have each been played several times.

10. The method of claim 9 wherein the order is received by a facilitator and wherein said facilitator has the golf balls marked and wherein the facilitator has the marked golf balls delivered to the driving ranges.

11. The method of claim 10 wherein the driving ranges each comprise a plurality of tee areas from which the members of the target audience play the marked golf balls and a field adjacent the tee areas into which the played golf balls land.

12. The method of claim 11 wherein the marked balls are collected from the field by an operator after the balls been played and wherein the operator returns the collected balls to the members of the target audience to be played again.

13. The method of claim 12 wherein the played golf balls are removed from the driving ranges after a time period, the time period selected to remove the balls before the balls become too worn out.

14. The method of claim 10 wherein the driving ranges are selected to lie within a preselected geographic area, the preselected geographic area corresponding to geographic areas the companies wish to promote their trademarks.

15. A method of promoting a plurality of companies to members of a target audience comprising the following steps:
a) receiving an order from each company to promote a trademark image belonging to each respective company to the members of the target audience,
b) acquiring a quantity of golf balls from a golf ball supplier,
c) marking said golf balls with the trademark images of said companies;
d) distributing the marked golf balls to a plurality of driving ranges to be played by the members of the target audience,
e) removing the marked golf balls from the driving range after the golf balls have each been played several times.

16. The method of claim 15 wherein the orders are received by a facilitator and wherein said facilitator marks the golf balls and wherein the facilitator delivers the marked golf balls to the driving ranges.

17. The method of claim 16 wherein the driving ranges each comprise a plurality of tee areas from which the members of the target audience play the marked golf balls and a field adjacent the tee areas into which the played golf balls land.

18. The method of claim 17 wherein the marked balls are collected from the field by an operator after the balls been played and wherein the operator returns the collected balls to the members of the target audience to be played again.

19. The method of claim 18 wherein the played golf balls are removed from the driving ranges after a time period, the time period selected to remove the balls before the balls become too worn out.

20. The method of claim 16 wherein the driving ranges are selected to lie within a preselected geographic area, the preselected geographic area corresponding to the geographic areas the companies wish to promote their trademarks.

21. The method of claim 15 wherein each golf ball is marked with the trademark images of only one company.

22. The method of claim 21 wherein each driving range receives a variety of differently marked golf balls and wherein the operator of the driving range provides at least some of the members with a variety of differently marked golf balls.

23. The method of claim 15 wherein at least some of the driving ranges receive only identically marked golf balls from the central location

24. The method of claim 16 wherein the golf balls are returned to the facilitator after the golf balls have been played several times.

25. The method of claim 15 wherein each member of the target audience playing at the driving range receives a plurality of marked golf balls each time the member plays.

26. The method of claim 15 wherein the driving ranges are selected to lie within a preselected geographic area, the preselected geographic area corresponding to geographic areas the companies wish to promote their trademarks.

27. The method of claim 15 wherein the played golf balls are removed from the driving ranges after a time period, the time period selected to remove the balls before the balls become too worn out.

28. The method of claim 16 wherein substantially all of the golf balls played at the driving ranges are marked balls delivered from the facilitator.

29. The method of claim 10 wherein substantially all of the golf balls played at the driving ranges are marked balls delivered from the facilitator.

30. The method of claim 9 further comprising the step of marking a percentage of the balls with a special marking, said specialty marked balls being distributed to the members, said specially marked balls being redeemable by the members receiving the specially marked ball for a prize.
